(19) United States
(12) Patent Application Publication
(10) Pub. No.: US 2009/0259786 A1
(43) Pub. Date: Oct. 15, 2009

(54) DATA TRANSFER SYSTEM AND METHOD FOR HOST-SLAVE INTERFACE WITH AUTOMATIC STATUS REPORT

(76) Inventors: Chu-Ming Lin, Hsinchu City (TW); Chien-Kuang Lin, Taipei County (TW); Chuan-Hung Wang, Kaohsiung County (TW); Chin-Tai Liu, Nantou County (TW)

Correspondence Address: NORTH AMERICA INTELLECTUAL PROPERTY CORPORATION, P.O. BOX 506, MERRIFIELD, VA, 22116, US

(21) Appl. No.: 12/339,072

(22) Filed: Dec. 19, 2008

Related U.S. Application Data
(60) Provisional application No. 61/007,529, filed on Apr. 10, 2008.

(51) Int. Cl. G06F 13/40

(52) U.S. Cl. 710/110

(57) ABSTRACT

In a host-slave data transfer system, the slave device transmits data regarding its status and buffer conditions to the host using tailers inserted into the data being transferred to the host. The slave device has a plurality of buffers, a buffer management circuit which manages the buffers and obtains buffer condition information (e.g. amount of available buffer space, amount of buffered data to be transferred to the host), a detection circuit which collects interrupt status of the slave, a processing circuit which generates headers or tailers containing the buffer conditions information and interrupt status, and a merging circuit which merges multiple data segments received from the data-source/data-destination device and associated headers and tailers to generate a stream of merged data. The host obtains the buffer condition information from the tailers, and uses it to determine the amount of data to transmit or receive from the slave.

This application claims priority from U.S. Provisional Patent Application No. 61/007,529, filed Apr. 10, 2008, which is herein incorporated by reference in its entirety.

### BACKGROUND OF THE INVENTION

1. Field of the Invention

The present invention relates to a data accessing system for a host-slave interface and related methods. In particular, it relates to such a data accessing system and related methods in which the slave automatically transmits device information to the host device without utilizing a request from the host.

2. Description of the Related Art

SDIO (Secure Digital Input Output) is an interface that uses the SD (Secure Digital) card form factor for devices other than flash memory cards. Such devices (the slave device in the SDIO interface) may include GPS receivers, Wi-Fi or Bluetooth adapters, modems, Ethernet adapters, barcode readers, IrDA adapters, FM radio tuners, TV tuners, RFID readers, digital cameras, mass storage media such as hard drives, etc. The host device (the master in the SDIO interface) that support SDIO may be PDAs (personal digital assistants), laptop computers, cell phones (“smart phones”), etc.

In a conventional host-slave system using the SDIO interface, the host device controls data transfer, and the slave device can only move data according to the host's request. The slave device cannot initiate data transfer. In data transfer, there is a time delay between the request sending of the host device and the request receiving of the slave device, and likewise there is a time delay between the response sending of the slave device and the response receiving of the host device. Such a situation is called inter-command delay. Because the slave device must wait for the host to request data, inter-command delay associated with the request command causes delay in data transfer. The inter-command delay may be as much as hundreds of microseconds.

For example, the slave device may have a plurality of buffers (a buffer pool) for buffering data to be transmitted or received, and the host device will need to know the available buffer space in the buffers before transmitting data to the slave device. Conventionally, the host device first sends a request to the slave to ask how much buffer space is available, therefore the inter-command delay problem of both the request and response sending will exist.

### SUMMARY OF THE INVENTION

Therefore, one objective of the present invention is to provide a data transfer system for a host-slave interface in which the slave device automatically transmits buffer condition information such as available buffer space, interrupt status, etc., to the host (master) device, instead of requiring the host device to request such information.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a slave device adapted for connecting to a host device for communicating data between the host device and an data-source/data-destination device, which includes: one or more buffers for storing data received from the data-source device and storing data received from the host device; a buffer management circuit coupled to the one or more buffers for obtaining buffer condition information indicating an amount of available space in one or more of the buffers and an amount of data received from the data-source device stored in one or more of the buffers; and a merging circuit coupled to the one or more buffers and to the buffer management circuit for generating a data stream and transferring the data stream to the host device, the data stream containing a plurality of main data segments and a plurality of auxiliary data segment associated with the main data segments, where the main data segments are obtained from the data received from the data-source device stored in the buffer, and wherein each of the auxiliary data segments contains the buffer condition information obtained by the buffer management circuit.

In another aspect, the present invention provides a method in a host-slave data transfer system, the slave being in data communication with an data-source/data-destination device, the method being implemented in the slave for transferring data to the host, which includes: (a) receiving data from the data-source device; (b) obtaining buffer condition information indicating an amount of available space in one or more buffers and an amount of data received from the data-source device stored in one or more buffers; (c) receiving a transfer command from the host; (d) in response to the transfer command, generating a data stream, the data stream containing a plurality of main data segments and a plurality of auxiliary data segment associated with the main data segments, where the main data segments are obtained from the data received from the data-source device stored in the buffer, and wherein each of the auxiliary data segments contains the buffer condition information; and (e) transferring the data stream to the host.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data transfer system according to an embodiment of the present invention.

FIG. 2 is a schematic diagram illustrating an example for the data format of merged data transmitted from the slave device to the host.

FIG. 3 is a schematic diagram illustrating an example of the tailer data format of the data transmitted from the slave device to the host.

FIGS. 4 and 5 are flow charts illustrating a data transfer method according to an embodiment of the present invention.

FIGS. 6 and 7 are exemplary embodiments of a data transfer system according to the present invention.

### DETAILED DESCRIPTION OF THE PREFERRED EMBODIMENTS

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

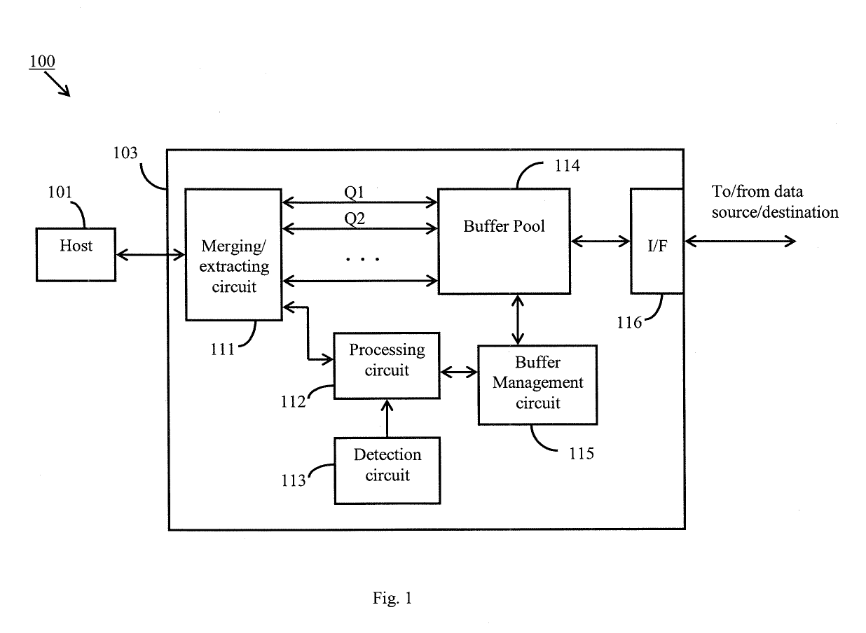

FIG. 1 is a block diagram illustrating a data transfer system 100 according to an embodiment of the present invention. As shown in FIG. 1, the data transfer system 100 includes a host (master) device 101 and a slave device 103 connected in a host-slave relationship. In a practical application, the host may be a PDA, a laptop computer, a cell phone, etc., and the slave device may be a GPS receiver, a Wi-Fi or Bluetooth adapters, a modem, an Ethernet adapter, a barcode reader, an IrDA adapter, an FM radio tuner, a TV tuner, an RFID reader, a digital camera, a mass storage device such as a hard drive, etc. In many applications, the slave device communicates with or receives signals from an data-source/data-destination device, such as GPS satellites, baseband system, a modem, a storage device, flush, a network, etc., using a communication protocol or data format compatible with the data-source/data-destination device. In this disclosure, the data-source/data-destination device is sometimes also referred to as a data-source device or an data-destination device depending on the context.

In one particular embodiment, the slave device has a SD (Secure Digital) card form factor. In other words, it has a connector with a physical shape and pin configuration that can be accepted by an SD card slot. In the example described below, the slave device is a communication adapter that facilitates data communication between the host 101 and an data-source/data-destination device (not shown).

The slave device 103 includes a merging/extracting circuit 111, a processing circuit 112, a detection circuit 113, a plurality of buffers (shown in FIG. 1 as a buffer pool) 114, a buffer management circuit 115, and an interface circuit 16. In this disclosure, the merging/extracting circuit 111 is sometimes also referred to as a merging circuit or an extracting circuit depending on the context. The buffers 114 temporarily stores data transferred between the data-source/data-destination device and the host 101. The plurality of buffers 114 form a plurality of logical queues (the terms “buffer” and “queue” are sometimes used interchangeably). In FIG. 1, the lines labeled Q1, Q2, . . . represents data from different buffers (queues) in the buffer pool, although the hardware connection may be a single line or multiple lines. The interface circuit 116 controls the data transmission with the data-source/data-destination device using appropriate communication protocols or data formats compatible with the data-source/data-destination device.

The buffer management circuit 115 manages the buffers in the buffer pool 114. For example, it determines how much data received from the data-source device is stored in each buffer and ready to be transferred to the host, how much free buffer space is available in each to receive data from the host. The detection circuit 113 collects the interrupt status of the slave device 103. Interrupt signals are generated by the system for error-control purposes, such as over-flow, under-flow, etc. The interrupts may be firmware interrupts or hardware interrupts.

During a receive transaction (i.e. reception of data from the data-source device by the host via the slave device), the processing circuit 112 generates header and/or tailer based on outputs of the buffer management circuit 115 and the detection circuit 113 as will be described in more detail later. The header and/or tailer are inputted to the merging circuit 111. The merging circuit 111 merges received data (from the data-source device) in the buffer pool and the header and/or tailer to generate a stream of merged data according to a predetermined data format as will be described later. In one embodiment, the merging circuit 111 includes a multiplexer that selects data from one of the plurality of buffers in the buffer pool 114. The merging circuit 111 transmits the merged data to the host device 101.

During a transmit transaction (i.e. transmission of data from the host to the data-destination device via the slave device), the extracting circuit 111 receives a data stream from the host. The data stream includes multiple headers each containing a designation of the buffer (queue) in which the data is to be placed. The processing circuit 112 extracts the header information from the data stream and provides it to the buffer management circuit 115. During the transmit transaction, the detection circuit 113 is disable in the slave device 103. In other words, the detection circuit 113 does not have a function while the slave device 103 transmits the packet-based data to the data-destination device. In some of embodiment for transmit transaction; the detection circuit 113 is omitted in the system. The buffer management circuit 115 controls the buffer usage for different queues according to the header to place the data from the host in the appropriate buffers of the buffer pool 114. The interface circuit 116 transmits the data from the buffer pool 114 to the data-destination device according to the appropriate communication protocol or data format compatible with the data-destination device.

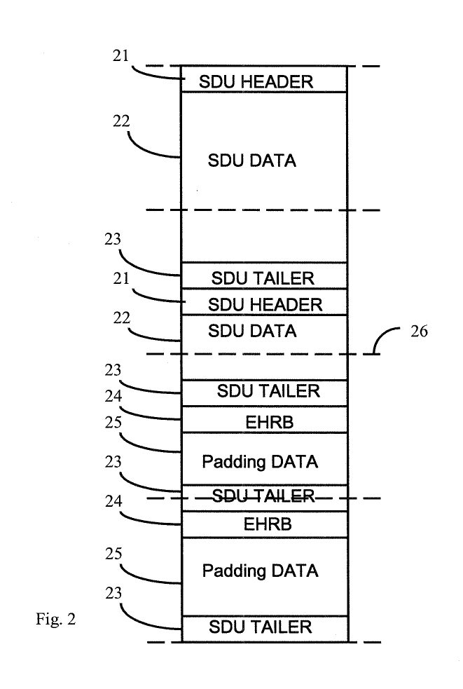

FIG. 2 is a schematic diagram illustrating an example for the data format of the merged data, which is generated by the merging circuit 111 and transmitted to the host device 101. The data received from the data-source device are typically packet-based data. The interface circuit 116 extracts the data content (“pure data”) from the data packets and places the pure data in the buffer pool. In the data structure shown in FIG. 2, each SDU (Service Data Unit) data segment 22 corresponds to the data content of a packet received from the data-source device. The merging circuit 111 adds a header 21 (“SDU header”) and a tailer 23 (“SDU tailer”) for each SDU data segment 22, and merges multiple such SDU data segments together with their headers and tailers into a data stream. A data stream is a continuous stream of data that is transferred to the host in response to one transfer command from the host.

It should be noted that the block boundary is irrelevant to the size of SDU since the block size is configurable initially between the slave and host and the size of SDU is the packet size with the header and tailer information. For example, the host may initially require a transaction to receive 10 blocks while each block contains 100 bytes; however, each SDU size varies (e.g. SDU size may be, for instance, 20 bytes, 650 bytes, 1K bytes, or other . . . ). Therefore, the slave transmits 10 blocks of data stream. These blocks may contain one, several, or only part of an SDU. The numbers of SDUs are only for exemplary purpose. As result, there might be some blocks that do not contain any SDU header or tailer. Another example is that there are 990 bytes of data ready to be received at the slave. The host can receive the data by requesting 10 blocks of data (each block contains 100 bytes in this case). At result, the data stream in this transaction contains 990 bytes of data along with 10 bytes of redundant data. The host can also receive the data by requesting a transaction with 9 blocks of data together with a second request to receive the remaining 90 bytes of data. In the above particular examples, each SDU tailer 23 contains information regarding the slave device, including the amount of data received from the data-source device that is ready to be transferred to the host and the amount of free buffer space available to the host to store data to be transmitted to the data-destination device event or to be received from the data-source device event (generally referred to as buffer condition information), interrupt status, and other information. Please note that the redundant data could be useful data or non-useful data depended on the design criteria. For example, the redundant bits may be repeating data, padded-zeros, unknown data, or a portion of the auxiliary data (can be the new auxiliary data or the old auxiliary data), etc. . . .

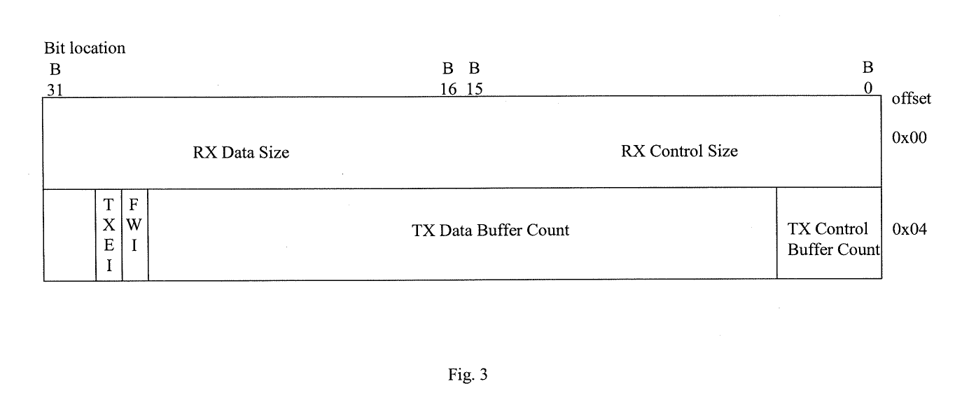

FIG. 3 is a schematic diagram illustrating an example of the data format of an SDU tailer 23. As shown in FIG. 3, the field Rx Data Size indicates the amount of received data (from the data-source device) buffered in the received data queue which is ready to be transferred to the host. The fields TX Data Buffer Count and TX Control Buffer Count indicate the amount of free space in the various transmit queues available to the host to place data to be transmitted to the data-destination device. The field Event Data Size indicates the amount of data in an event queue, which is a queue separate from the receive and transmit queues, and is sent through a different data port. The field TXEI indicates transmission error interrupt status, and the field FWI indicates firmware interrupt status.

Of course, the tailer data former illustrated in FIG. 3 is merely an example. The number of fields and the definitions of the parameters in a tailer are not limited to those shown in FIG. 3; any desired status information regarding the slave device can be placed in the tailer. Further, the location of the SDU tailer is not important; it is not required to be located after the end of the SDU. In addition, the buffer condition and interrupt status information can alternatively be placed in a header. More generally, the header and/or tailer may be collectively referred to as the auxiliary data segment while the SDU may be referred to as the main data segment. The auxiliary data in the present disclosure refers to all information other than information of main data. The auxiliary data may be any information that host would like to acknowledge of with the exception of the main data.

Referring back to FIG. 2, the horizontal dash lines 26 schematically indicate block boundaries. In SDIO, as well as many other protocols, the host device transfers data in blocks. SDIO uses multiple blocks in a transfer to access mass data. The block size is configurable in the range from 1 B to 2 KB. Each SDU data segment, on the other hand, may have variable sizes. The predetermined of block size is determined by the host and host indicate the predetermined of block size in one data stream to the slave. FIG. 2 shows two SDUs 22 of different sizes. The data stream generated by the merging circuit 111 contains multiple SDU data segments together with their headers and tailers. The data stream is transferred as multiple blocks, and the block boundaries may fall anywhere in the data stream, such as inside an SDU data segment 22, inside an SDU header 21, inside an SDU tailer 23, etc. It should be noted that the method can be applicable to other master-slave communication systems, such as USB. For the USB system, a block based concept does not exist. Instead, the maximum packet size can be considered as the block size in the example of SDIO.

In the example shown in FIG. 2, the special header EHRB (End Header Receive Block) 24 indicates that the requested data has ended and what follows is padding data 25 rather than SDU data. This situation may occur in the last one of the multiple blocks of data, or when the host requested more data than is ready for transfer on the slave device. Even when padding data 25 follows the special SDU header 24, an SDU tailer containing the buffer condition and interrupt status information is still added after the padding data so that the most current information regarding the slave is provides to the host device.

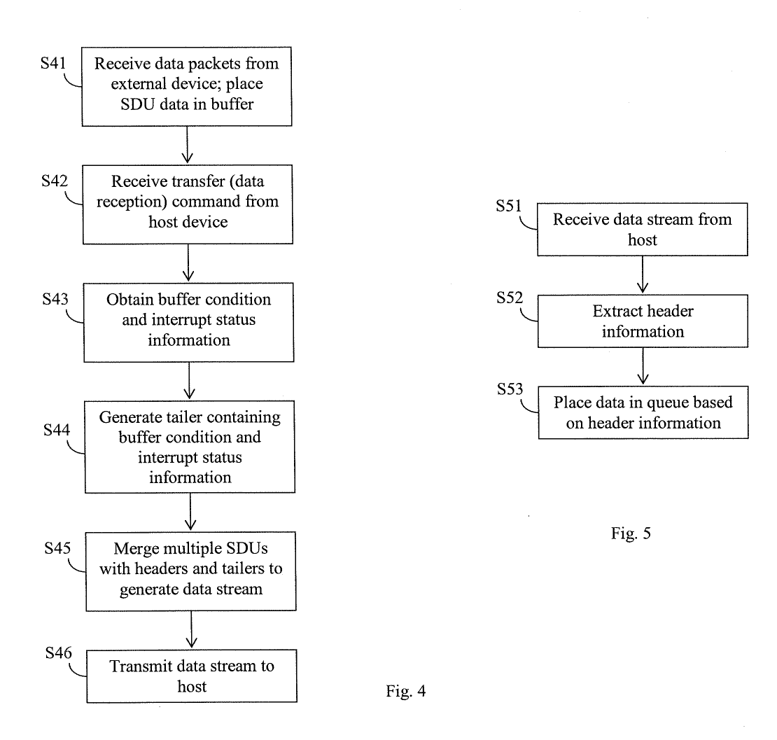

FIGS. 4 and 5 are flow diagrams illustrating a data transfer method executed by the slave device 103 according to an embodiment of the present invention. FIG. 4 illustrates a receive transaction (i.e. the host device 101 received data from the data-source device via the slave device 103); FIG. 5 illustrates a transmit transaction (i.e. the host device 101 transmits data to the data-destination device via the slave device 103). As shown in FIG. 4, the slave device receives data from the data-source device and stores it in a buffer (step S41). As mentioned earlier, the data received from the data-source device are typically packet-based data, and the data content (“pure data”) is extracted from the data packets and placed in the buffer. The slave receives a transfer command from the host (step S42), in this case a command to receive data. The buffer management circuit 115 obtains buffer condition information and the detection circuit 113 obtains interrupt status (step S43). The processing circuit 112 generates tailers containing the buffer condition information and interrupt status (step S44). The order of steps S42, S43 and S44 is not important. The merging circuit 111 then merges multiple SDUs with headers and tailers to generate a data stream (step S45). The data stream is transferred to the host (step S46). This process repeats so that more data is received from the data-source device and transferred to the host.

It should be noted that the process of obtaining the buffer condition information and interrupt status is continuous, and the tailer always contains the most recent such information. Thus, the host can in fact skip some of the tailers because subsequent tailers always contain the current information.

In a transmit transaction, as shown in FIG. 5, the slave device receives a data stream from the host (step S51). Similar to the data stream transferred by the slave to the host, the data stream received from the host contains multiple SDUs with headers and tailers. The header contains information regarding which queue the data is to be placed in. The processing circuit 112 extracts this information from the header (step S52), and the buffer management circuit 115 controls the buffer pool to place the data in the appropriate queue (step S53). This process repeats so that more data is received from the host and transferred to the data-destination device.

In addition (not shown in FIGS. 4 or 5), if in a time period there are continuous transmit transactions without receive transactions, the slave device will lack an opportunity to send the updated buffer condition information and interrupt status to the host. In this situation, the slave device may send an interrupt signal to the host, in response to which the host sends a command to the slave to request the information. Alternatively, the host may send a command to the slave if there has not been a receive transaction for a predetermined time period.

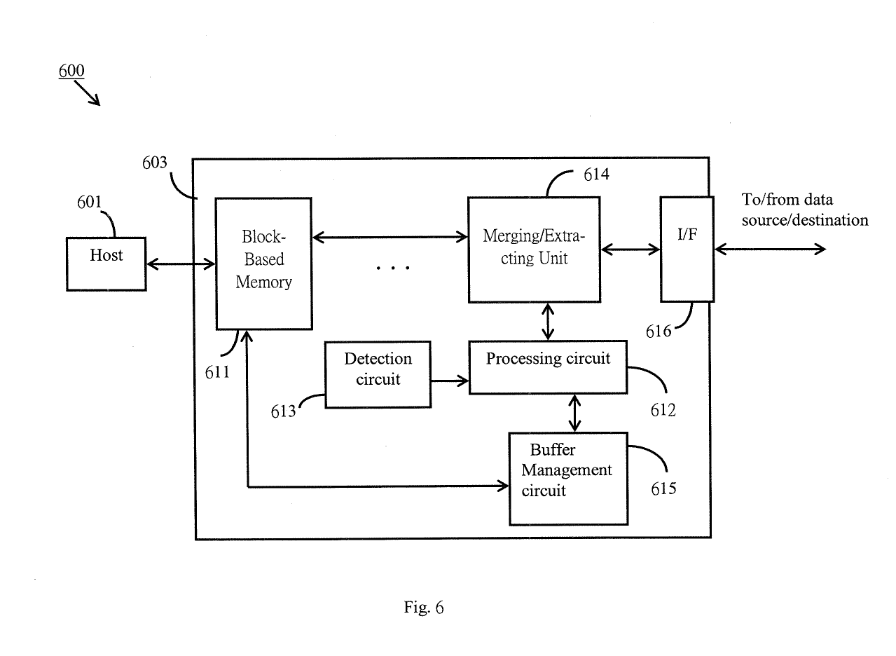

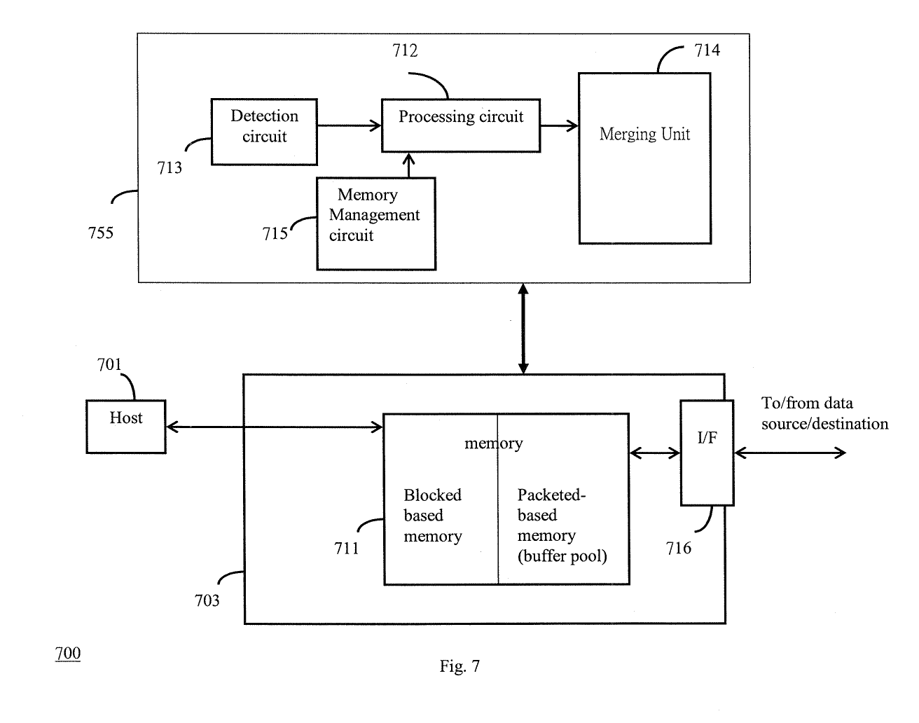

Please note that the structure illustrated in FIG. 1 is the prefer embodiment of the present invention. However, there are other exemplary embodiments might utilize of the present invention; for example, FIG. 6 and FIG. 7. In FIG. 6, the merging/extracting unit 614 receives the packet-based data from the data sourcing device and merges the packet-based data into the block-based data. The memory 611 receives the block-based data from the merging unit 614 and stores those data in the block-based manner. Please note that the memory is different from the buffer queue in the FIG. 1 since the buffer queue in the FIG. 1 stores the data in the packet-based manner. The buffer management circuit 615 obtains the memory condition from the memory 615 and forwards the buffer condition to the processing circuit 612. The detection circuit 613 also transmits the interrupt status to the processing circuit 612. The processing circuit 612 generates the auxiliary data according to the input from the buffer management circuit 615 and detection circuit 612. The processing circuit 612 forwards the auxiliary data to the merging unit 614 for combining with the main data. The auxiliary data and main data are both stored in the memory 611 in the block-based and transmit the data stream to the host 601. While the datastream is transmitted from the host 611 to the data destination device, the context is similar to what it is illustrated in the description for the exemplary embodiment of FIG. 1 and the detail information is omitted for brevity. In addition, some other contexts are illustrated in FIG. 1 and those would not be repeated since those are similar to the descriptions through FIG. 1-5 and it should be understood by one who is in the relevant art from reading the description in detail. In FIG. 7, the external module 755 is introduced and wherein the external module comprises the detection circuit 713, processing circuit 712, memory management circuit 715 and merging circuit 714. The slave device comprises a memory for storing the packet-based data and block-based data. The memory 711 of this specific exemplary embodiment needs to be able to store the packet-based data and block-based data. The memory 711 receives the packet-based data and stores into the memory. The stored packet-based data are transferred to the external module 755 for merging and processing. In addition, the memory condition is also transmitted to the external module 755. The merging unit 714 in the external module 755 merges the data based on processing circuit output and data from the slave device 703. In addition, the memory management 715 in the external device 755 from the slave device 703. The detection unit 713 receives the control information from the host 701 or slave 703 device. The host 701 can directly transmit the control information to the external module 755 or transmit to the slave device 703 first and forward to external module 755. Once the main data and auxiliary data are merged into the block-level, the block-based data are transmitted to the memory 711 and forwards to the host 701. For the case of the host 701 transmitting data to the data destination is quite similar to the detail information as illustrated for FIG. 1; thus, it is omitted for brevity. Of course, the present invention does not limit to the exemplary embodiments of FIGS. 1, 6, 7 and those are only for illustration purpose, and there are still exemplary embodiments, such as the external device only consisting of processing circuit, detection circuit, and buffer management circuit.

The data transfer method described here has many advantages over conventional SDIO systems or other similar systems. In conventional SDIO host-slave transfer methods, each data transfer only transfers one SDU (in one or more blocks). Because each data transfer requires a command from the host, such a transfer method required multiple command cycles to transfer multiple SDUs, resulting in inter-command delay. In addition, because each SDU typically does not have a size of a multiple of blocks, each SDU transfer will result in a waste of some space in the last block. Alternatively, the SDU may be transferred by first transferring a number of blocks and then transferring a number of bytes, but this again involves multiple transfer commands issued by the host and results in inter-command delay.

The advantages of the data transfer method described here are as follows. First, it reduces inter-command delay by reducing the number of commands the host needs to send to the slave in order to obtain relevant information such as the available buffer size and amount of buffered data ready to be transferred to the host, interrupt status, etc. This is accomplished by the use of SDU tailer to send the buffer condition and interrupt status information to the host automatically. Second, it reduces inter-command delay because transferring multiple SDUs in a data stream reduces the number of transmit or receive commands. Each data stream containing multiple SDUs is continuously transferred to the host without requiring additional transfer command from the host. Third, because the slave device informs the host of the amount of data buffered in the slave and ready to be transferred to the host, the host can timely transfer the data. This reduces the idle time on the slave. Fourth, because the host has information about the available buffer space and amount of buffered data ready for transfer, the host can send or request an appropriate amount of continuous data by each command, reducing the number of commands and inter-command delay.

Further, the method described here facilitates the implementation of multiple queues on the slave of host-slave data transfer system. As mentioned above, the slave according to embodiments of the present invention has multiple queues, each queue being a logical queue with its own buffer memory. Implementing multiple queues offers flexibility in data handling. For example, the queues may have different priorities assigned to them. Implementing multiple queues in a conventional SDIO system would require a high overhead because the host would have to use many commands to obtain the information about the status of each queue, such as the amount of data buffered in the queue, the amount of available space, etc. Using the method described here, updated information about the queues is automatically sent by the slave device, eliminating the need for the host to use commands to obtain such information.

It should be noted that although the SDIO system is used as an example in the above descriptions, the invention is not limited to SDIO, and can be applied in other host-slave interface systems such as USB.

It will be apparent to those skilled in the art that various modification and variations can be made in the host-slave data transfer system and related method of the present invention without departing from the spirit or scope of the invention. Thus, it is intended that the present invention cover modifications and variations that come within the scope of the appended claims and their equivalents.

What is claimed is:

1. A slave device adapted to a host device for communicating data between the host device and an data-source device, comprising:
one or more buffers for storing data received from the data-source device;
a buffer management circuit coupled to the one or more buffers for obtaining buffer condition information indicating an amount of available space in one or more of the buffers and an amount of data received from the data-source device stored in one or more of the buffers; and
a merging circuit coupled to the one or more buffers and to the buffer management circuit for generating a data stream and transferring the data stream to the host device, the data stream containing a plurality of main data segments and a plurality of auxiliary data segment associated with the main data segments, where the main data segments include the data received from the data-source device stored in the buffer, and wherein each of the auxiliary data segments comprises the buffer condition information obtained by the buffer management circuit.

2. The slave device of claim 1, further comprising a processing circuit coupled between the buffer management circuit and the merging circuit for generating the auxiliary data segment based on the buffer condition information and providing the auxiliary data segments to the merging circuit.

3. The slave device of claim 1, further comprising a detection circuit coupled to the merging circuit for detecting interrupt status of the slave device, wherein the auxiliary data segments in the data stream further contains information regarding the interrupt status.

4. The slave device of claim 1, wherein the one or more buffers include one or more receive buffers for storing data received from the data-source device to be transferred to the host device,
wherein the buffer condition information in the auxiliary data segment includes an amount of available space in each receive buffer.

5. The slave device of claim 1, further comprising an interface circuit for controlling data communication between the slave device and the data-source device using a predetermined communication protocol, wherein the data received from the data-source device includes a plurality of data packets, wherein the interface circuit extracts data content from the data packets and places the extracted data in the one or more buffers, and wherein each main data segment in the data stream generated by the merging circuit contains the extracted data content of one data packet.

6. The slave device of claim 1, wherein the merging circuit transfers the data stream to the host in a block-based manner.

7. The slave device of claim 6, wherein the data stream comprises pluralities of blocks and each of blocks comprise a predetermined size, wherein a size of the data stream and a size of each block are determined by the host device.

8. The slave device of claim 7, further comprising a processor for generating at least one redundant bits to be padded into a portion of at least one of the blocks in the data stream if the size of the data stream is greater than a total size of the main data and the auxiliary data intended to be transmitted to the host device.

9. The slave device of claim 7, whereby the data stream transmitting to the host device is a first transaction and another data stream transmitting to the host device after the first action being completed is a second transaction, wherein the merging circuit for transmitting a portion of the main data and the auxiliary data intended to be transmitted to the host device at the second transaction if the size of the data stream is less than a total size of the main data and the auxiliary data intended to be transmitted to the host device.

10. The slave device of claim 1, where the auxiliary data segments are tailers located after the respective main data segments.

11. In a host-slave data transfer system, the slave being in data communication with an data-source device, a method implemented in the slave for transferring data between the host and the slave device, comprising:
(a) receiving data from the data-source device;
(b) obtaining condition information indicating an amount of available space in a memory and an amount of data received from the data-source device stored in the memory;
(c) receiving a transfer command from the host;
(d) in response to the transfer command, generating a data stream, the data stream containing a plurality of main data segments and a plurality of auxiliary data segment associated with the main data segments, where the main data segments include data received from the data-source device, and wherein each of the auxiliary data segments contains the condition information; and
(e) transferring the data stream to the host.

12. The method of claim 11, wherein step (d) comprises:
(d1) generating the auxiliary data segment based on the condition information, wherein the condition information further comprises the information slave intends to transmit to the host; and
(d2) merging the data received from the data-source device and the auxiliary data segments to generate the data stream, wherein the data stream is transmitted in block-based manner.

13. The method of claim 11, further comprising:
(f) detecting interrupt status of the slave device,
wherein the auxiliary data segments in the data stream further contains information regarding the interrupt status.

14. The method of claim 11, where the auxiliary data segments are tailers located after the respective main data segments.

15. A device for communicating data with a host device, comprising:
an extracting circuit for receiving a data stream from the host device and for splitting the data stream into plurality of packet-based data;
a processing unit for extracting a header information from the data stream;
one or more buffers for storing the packet-based data received from the extracting circuit, wherein the one or more buffers includes a plurality of transmit buffers and each buffer has an assigned priority; and
a buffer management circuit coupled to the one or more buffers for controlling each buffer usage according to the header information and placing the split data from the extracting circuit into the appropriate buffers of the buffer pool, wherein the header information contains a designation of a buffer in which the data is to be placed.

16. A slave device adapted to a host device for communicating data between the host device and an data-source device, comprising:
a connector having a Secure Digital Input Output interface (SDIO interface) or Universal Serial Bus interface (USB interface) for connecting to the host device;
one or more buffers for storing data received from the data-source device and storing data received from the host device;
a communication interface for communicating data with the data-source device, wherein the data received from the data-source device include a plurality of data packets, wherein each of the buffers stores the at least one data packet; and
a merging circuit coupled to the one or more buffers for generating a data stream by merging each data packet stored in each buffer and transferring the data stream to the host device, the data stream containing a plurality of data segments, wherein the data stream is a continuous stream.

17. The slave device of claim 16, further comprising a buffer management circuit coupled to the one or more buffers for obtaining buffer condition information including an amount of available space in one or more of the buffers and an amount of data received from the data-source device stored in one or more of the buffers,
wherein the data stream further containing a plurality of auxiliary segments associated with the data segments, wherein each of the auxiliary segments contains the buffer condition information.

18. The slave device of claim 16, further comprising a detection circuit coupled to the merging circuit for detecting interrupt status of the slave device, wherein the auxiliary segments in the data stream further contains information regarding the interrupt status.

19. The slave device of claim 18, where the auxiliary segments are tailers located after the respective data segments.
